(19) United States
(12) Patent Application Publication
(10) Pub. No.: US 2003/0077050 A1
(43) Pub. Date: Apr. 24, 2003

(54) Method for passive alignment of supports, particularly plates bearing optical components

(76) Inventors: Francois Marion, St Egreve (FR); Cecile Bory, Le Fontanil (FR)

Correspondence Address: Thelen Reid & Priest, PO Box 640640, San Jose, CA, 95164-0640, US

(21) Appl. No.: 10/168,997

(22) PCT Filed: Oct. 24, 2001
(86) PCT No.: PCT/FR01/03301

(30) Foreign Application Priority Data
Oct. 25, 2000 (FR) 00/13680

(51) Int. Cl. G02B 6/42; G02B 6/26

(52) U.S. Cl. 385/90; 385/52

(57) ABSTRACT

A process and a device for the passive alignment of supports, particularly plates which carry optical components.

According to the invention, in order to align supports (2, 8), holes (6, 7, 11, 12) are formed in these supports, in correspondence with each other, balls (14, 16) are placed on the holes of one of the supports and these are assembled by placing the holes of the other support onto the balls. The sizes of the holes or of the balls are chosen so as to obtain a pre-set non-zero angle (α) between the assembled supports.

### TECHNICAL FIELD

The present invention relates to a process and a device for the passive alignment of supports.

It finds applications particularly in the field of optics, for example for the passive alignment of plates carrying optical components.

The invention also applies to the field of MEMS or micro-electro-mechanical systems.

More generally, the invention finds applications in all the fields where it is necessary to make a precise alignment of supports, for example in plate form.

### PRIOR ART

Techniques are already known allowing two plates to be aligned and assembled one relative to the other, with good precision and without a common alignment support.

In particular active techniques are known according to which optical markers are formed on the two plates, the two plates are aligned optically or electrically and they are assembled by holding them in the clamped (by bonding, welding or mechanical holding) alignment position.

Passive techniques are also known according to which elements are formed on the plates, these elements allowing the two plates to self-align and then be clamped; this is for example the flip-chip technique in which the plates self-align through the self-aligning property of solder balls in a molten state.

It should be said at the outset that the invention forms part of the techniques of passive alignment and allows two approximately plane parts to be aligned and then clamped with no need for optical alignment when the two parts are assembled.

A technique of passively aligning two components is already known from the following document:

[1] Passive alignment member for vertical surface emitting/detecting devices, WO 99/44088, The Whitaker Corporation.

Other techniques are also known allowing optical alignment, from the following documents:

[2] Self-aligning support structure for optical components, U.S. Pat. No. 4,079,404, L. D. Comerford et al.

[3] Microjoinery: concepts, definition, and application to microsystem development, Sensors and actuators A 66 (1998) pp.315-332.

It is desirable to be able to clamp two supports (for example two plates) mechanically to each other, in such a way that these two supports

are perfectly aligned one relative to the other after clamping (relative to spatial markers formed on each of the supports before they are assembled) and

may also make an angle between themselves.

This problem is partially resolved by the technique disclosed in document [1]. This technique makes it possible to align two components one relative to the other, along two perpendicular directions X and Y, but does not allow them to be aligned along a third direction Z, perpendicular to the directions X and Y, without using spacers or other similar means to control the spacing of the components.

### DISCLOSURE OF THE INVENTION

The purpose of the present invention is to overcome the previous drawbacks.

The invention aims to align in a precise and passive way at least two supports, particularly two plates which carry optical components such as, for example one or more optical fibres or one or more light sources and/or receptors.

The invention makes it possible to assemble these two supports with precision, along the three axes X, Y and Z perpendicular to each other, and to control the angle which these two supports make between them.

The precise objective of the present invention is a process for the passive alignment of at least one first support and at least one second support, this process being characterised in that:

at least three first holes are formed in the first support from a first surface of this first support,

at least three second holes are formed in the second support from a first surface of this second support, these second holes being able to be facing the first holes when the first surfaces of the first and second supports are placed facing each other,

balls are placed on the first holes respectively, the size of each ball being greater than the size of the first hole corresponding to this ball and than the size of the second hole corresponding to this first hole, and

the first and second supports are assembled by placing the second holes onto the balls which are on the first holes corresponding respectively to these second holes,

and in that the sizes of the first and second holes and/or the sizes of the balls are chosen so as to obtain a pre-set non-zero angle between the respective first surfaces of the first and second assembled supports.

According to a preferred mode of implementing the process which is the subject of the invention, the first support is additionally clamped to the second support

According to a particular embodiment of the invention, the first support is clamped to the second support using a technique chosen from among bonding by coating, the pre-depositing of an adhesive on the first support before assembling the first and second supports, localised bonding by gluing the balls before this assembly, and clamping by a mechanical clamping means.

To assist the assembly of the first and second supports before clamping them to each other, this assembly may be made to vibrate.

Preferably, the first and second holes are not all of the same size.

In one example of the invention, the three first holes (and, clearly, the three second corresponding holes) are placed approximately at the apexes of an isosceles triangle, two of these three first holes being of approximately the same size and delimiting the base of this isosceles triangle while the third hole is of smaller size.

According to one particular mode of implementing the invention, N first supports and N second supports associated respectively with the N first supports are used, N being a whole number greater than one, each of the N assemblies of associated first and second supports being coated with a polymerisable adhesive and the adhesive of the N assemblies is simultaneously cross-linked.

The materials of which the first and second supports are made are chosen for example from among silicon, quartz, glass and metals.

The balls, for their part, are made for example of corundum or stainless steel or a fusible material.

Another purpose of the present invention is a device for the passive alignment of at least one first support and at least one second support, this device being characterised in that the first support includes at least three first holes formed from a first surface of this first support and the second support includes at least three second holes formed from a first surface of this second support, these second holes being able to be facing the first holes when the first surfaces of the first and second supports are placed facing each other, the first holes being intended to receive balls allowing the assembly of the first and second supports by placing the second holes onto the balls which are on the first holes corresponding respectively to these second holes, the size of each ball being greater than the size of the first hole corresponding to this ball and than the size of the second hole corresponding to this first hole, and the sizes of the first and second holes and/or the sizes of the balls being chosen so as to obtain a pre-set non-zero angle between the first surfaces of the first and second assembled supports.

According to a particular embodiment of the device which is the subject of the invention, the first support comprises at least one first optical component and the second support comprises at least one second optical component able to be facing the first optical component when the second holes are facing the first holes, the device thus allowing the passive alignment of the first optical component and of the second optical component.

### BRIEF DESCRIPTION OF THE DRAWINGS

The present invention will be better understood from reading the description of embodiment examples given below, purely as an illustration and in no way restrictively, with reference to the appended drawings in which:

FIG. 1 is a diagrammatic cross-section view of a particular embodiment of the device which is the subject of the invention,

FIG. 2 shows diagrammatically a particular mode of implementing the process which is the subject of the invention,

FIG. 3 is a diagrammatic cross-section of a ball which is placed in a hole formed in a support in order to implement a process in accordance with the invention,

FIG. 4 is a diagrammatic view from above of a support provided with three holes, for implementing a process in accordance with the invention,

FIG. 5 is a diagrammatic view from above of another support provided with more than three holes, for implementing another process in accordance with the invention, and

FIG. 6 is a diagrammatic cross-section view of another particular embodiment of the device which is the subject of the invention, allowing the alignment of one or of a plurality of optical fibres and of one or of a plurality of light sources or detectors.

### DETAILED DISCLOSURE OF PARTICULAR EMBODIMENTS

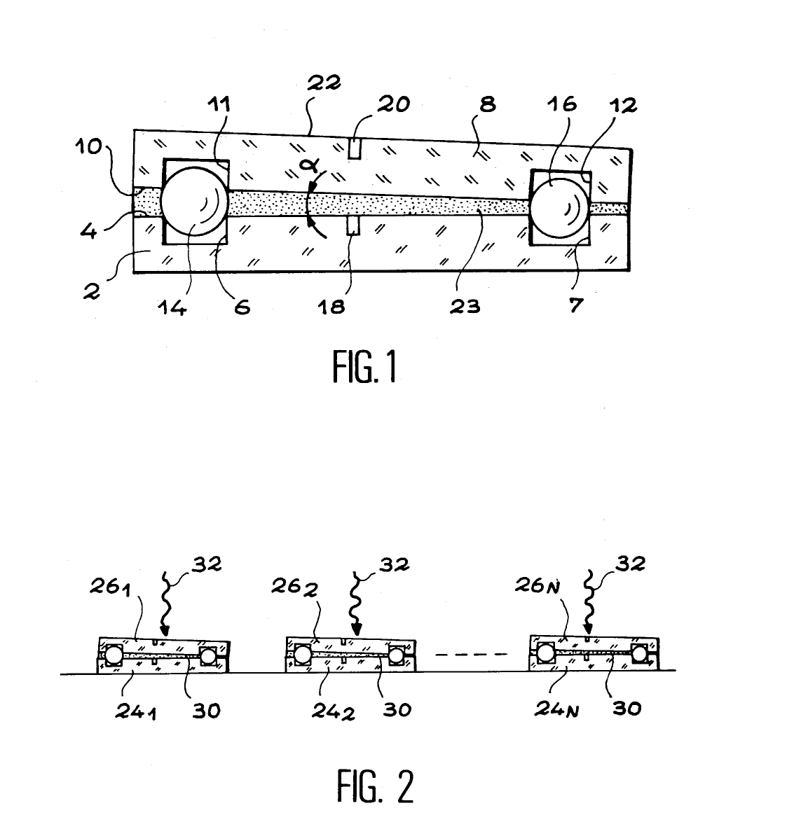

The example of the device which is the subject of the invention, which is shown diagrammatically in cross-section in FIG. 1, includes a first support 2, in the form of a plate, comprising three non-aligned blind holes, formed from a surface 4 of this plate.

In FIG. 1, only two of these holes can be seen; they bear the reference numbers 6 and 7. The third one is located behind the hole 6, in the left-hand part of FIG. 1.

The device in FIG. 1 also includes a second support 8, in the form of a plate, which is also provided with three non-aligned blind holes, formed from a surface 10 of this second support. Only two of these holes, which have been given the reference numbers 11 and 12, can be seen. The third one is located behind the hole 11, in the left-hand part of FIG. 1.

A plate of the same type as the plates 2 and 8 is shown in a view from above in FIG. 4 which will be described later.

The holes in the two supports are formed in such a way that those in the support 8 are located respectively in correspondence with those in the support 2 when the surfaces 4 and 10 of the supports are facing each other.

The device in FIG. 1 also includes three alignment balls, more straightforwardly called “balls” in the remainder of the description. They are associated respectively with the holes with which the supports are provided. Only two of these balls 14 and 16 can be seen in FIG. 1, the ball 14 being associated with the holes 6 and 11 whereas the ball 16 is associated with the holes 7 and 12.

Each ball is placed onto the hole of the plate 2 which corresponds to it and the plate 8 is placed above the plate 2 in such a way that each hole of this plate 8 is on the ball corresponding to this hole.

The diameter of each ball is greater than the diameters of the two holes of the plates 2 and 8 corresponding to this ball, the diameters of these holes being equal in the example in FIG. 1.

Also in FIG. 1 can be seen an optical component 18 which is formed on the plate 2 and another optical component 20 which is formed on the plate 8 and aligned approximately with the component 18, the holes and the balls engaging so that this alignment is obtained when the plates are assembled.

In the example in FIG. 1, the component 18 is a light source and the component 20 is a light detector; the component 18 is formed on the surface 4 of the plate 2 whereas the component 20 is formed on the upper surface 22 of the plate 8, a surface which is opposite the surface 10 of this plate 8; the latter is made of a material transparent to the light emitted by the component 18 so that this light can reach the detector 20

The plate 2 is made integral with the plate 8 by means of a layer of adhesive 23.

In the example in FIG. 1 an adhesive is used which is transparent to the light emitted by the component 18 in such a way that this light can pass through the part of the adhesive between the plates.

It is pointed out that the diameter of the ball 16 is greater than the diameters of the two other balls, which are identical in the example in FIG. 1. In this way a non-zero angle α is obtained between the plates 2 and 8.

More generally, it is possible to obtain an angle of pre-set, non-zero, value between the plates 2 and 8, by choosing appropriate values for the diameters of the balls or the diameters of the holes or both the diameters of the balls and of the holes.

It should be noted that a zero angle is obtained between the plates by using identical holes and identical balls (of diameter greater than that of the holes).

The passive alignment of the plates 2 and 8 will now be explained.

To begin with the balls are deposited onto the corresponding holes of the plates 2. Each ball is wedged by gravity into the hole which corresponds to it. Next the plate 8 is roughly aligned on the plate 2 and this plate 8 is deposited onto the plate 2 in such a way that at least the apex of each ball is opposite the corresponding hole of the plate 8. A self-alignment of the plates 2 and 8 is then obtained by gravity.

It is possible to assist this self-alignment by vibration.

Imprecisions of positioning due to friction are thus restricted.

To obtain these vibrations ultrasound or vibrating discs are used.

The plate 8 is then bonded onto the plate 2. To do this, an adhesive coating technique is used, for example the technique described in the following document:

(4) Process for coating electronic components hybridized by bumps on a substrate, U.S. Pat. No. 5,496,769, F. Marion and M. Boitel, see also FR 2 704 691.

Instead of bonding the plates by adhesive coating, it is possible to pre-deposit adhesive onto the plate 2 before placing the plate 8 onto this plate 2. As a variant, it is possible to bond in a localised way by gluing the balls before placing the plate 8 onto the plate 2. Instead of this, a mechanical clamping means may be used, for example screws or springs able to clamp the plate 8 onto the plate 2.

Advantages of the invention will now be given:

It allows two parts to be added together with a basic pre-alignment, with better precision than the half-size of the shaped holes; and the final alignment, after self-alignment, may be extremely precise (about 1 μm according to the precision of the holes).

Moreover, it allows a very precise angle α to be obtained between the parts.

Additionally, to form a device in accordance with the invention, it is not necessary to use a complex and expensive positioning machine.

FIG. 2 shows diagrammatically an example of the process according to the invention, allowing the joint manufacture of several devices of the type of device in FIG. 1.

To do this N plates 24₁, 24₂ . . . 24_{N} are used which are placed onto an appropriate surface 26, N being a whole number greater than 1. With these plates 24₁, 24₂ . . . 24_{N} are associated N other plates 28₁, 28₂ . . . 28_{N} respectively.

All these plates are again provided with holes and assembled to each other using balls to obtain N assemblies of the same type as that in FIG. 1.

Next each of the N assemblies is coated using an adhesive 30 which can be polymerised by ultraviolet radiation then the adhesive of the N assemblies is simultaneously cross-linked by means of such ultraviolet radiation 32.

The joint character of the assembly of the plates so formed is important since the alignment and bonding processes in normal use mean that a pair of parts, which it is desired to clamp to each other, have to be held throughout the entire adhesive hardening process. The result is that such pairs of parts have to be assembled one after another. The total cross-linking time is then equal to N times the cross-linking time per piece. The alignment and bonding machine is used throughout this time and its capacity, expressed as “parts per hour” is very small.

Conversely, the self-alignment implemented in the example of the present invention, shown in FIG. 4, does not require the pairs of plates to be held during cross-linking. Total cross-linking time is equal to the cross-linking time of the adhesive of a single pair of plates. This operation may be carried out with a machine other than the alignment machine. A simple oven is used for example for a thermal cross-linking adhesive and an ultraviolet radiation flux for an adhesive, which can be cross-linked by such radiation.

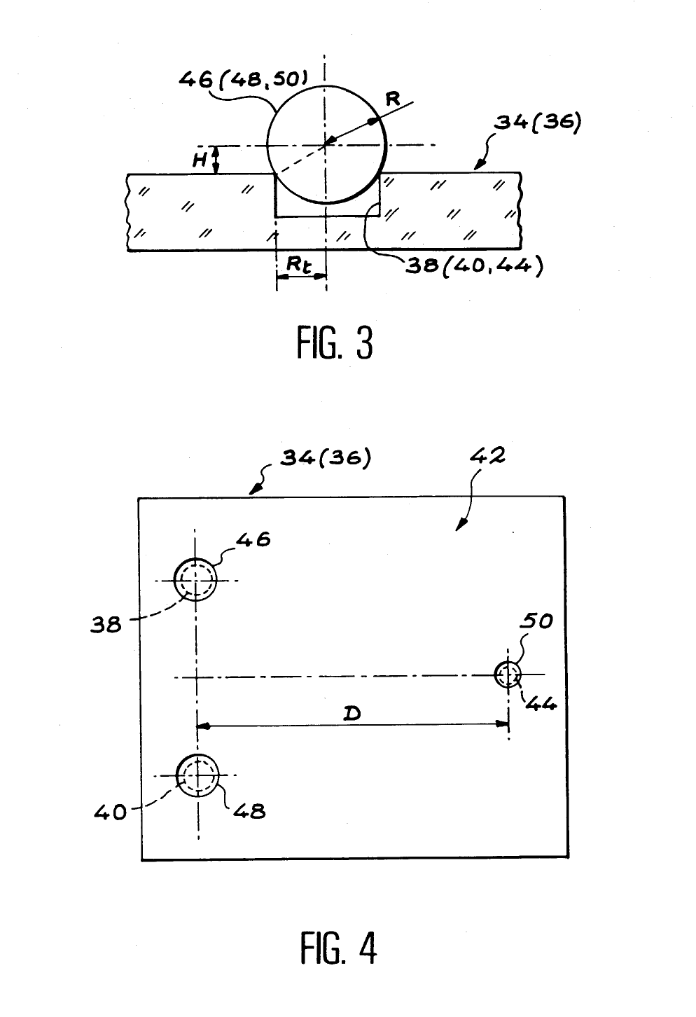

A digital example will now be given, purely by way of illustration and in no way restrictively, of an implementation of the present invention with reference to FIGS. 3 and 4.

It is required to align two optical components face-to-face with a precision better than 2 μm. To do this, two plates are formed 34 and 36 provided respectively with these two optical components and each comprising two holes 38 and 40 of depth equal to 200 μm +/−2 μm, these two holes being 800 μm apart.

In FIG. 4 can be seen the surface 42 of the plate 34 or 36 from which these two holes 38 and 40 are formed.

A third hole 44 is formed from this surface 42. The centre of this third hole is found on the mediator of the segment joining the centres of the two holes and at a distance D from this segment equal to 5 mm.

Onto the holes 38 and 40 are deposited balls 46 and 48 with a diameter of 240 μm+/−2 μm and a ball 50 with a diameter of 120 μm is deposited on the hole 44 the diameter of which is 100 μm.

FIG. 3 shows a ball 46 or 48 or 50 placed on a hole 38 or 40 or 44 formed in the plate 34 or 36. The radius of the ball is denoted R and the radius of the hole Rₜ. The distance between the centre of the ball and the plane of the upper surface of the plate is denoted H. For the two balls 46 and 48, H takes a value H₁. For the third ball 50, H takes a value H₂. Now H is equal to the square root of (R²−R²ₜ). H₁ is therefore equal to 66 μm and H₁ to 33 μm.

Therefore the plates 34 and 36 are spaced apart by 132 μm at the level of the two balls 46 and 48 and finally positioned at better than 2 μm if the holes and the balls are formed with a precision better than 2 μm. Initial pre-positioning tolerance is +/−100 μm (half-diameter of the holes).

The angle between the two plates 34 and 36 is little different from (H₂−H₁)/D in other words 0.38°.

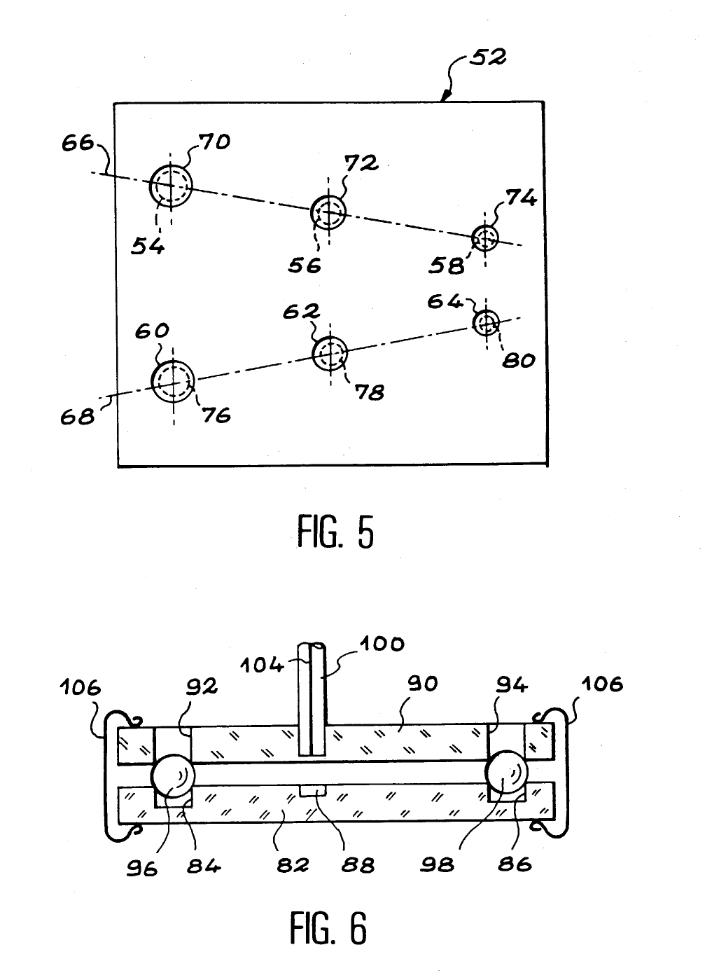

FIG. 5 is a diagrammatic and partial view from above of a plate 52 which may be used (in duplicate) in the invention. This plate includes more than three holes, for examples two sets of three holes 54-56-58 and 60-62-64 formed respectively along the two lines 66 and 68 which are not parallel. The three aligned holes 54, 56 and 58 are of decreasing diameter and the three other holes 60, 62 and 64 are identical respectively to the three holes 54, 56 and 58 and spaced apart like the latter.

Into the holes 54, 56 and 58 are placed balls 70, 72 and 74 of decreasing diameter, greater than the diameters of the corresponding holes, and into the holes 76, 78 and 80, balls 76, 78 and 80 identical to the balls 70, 72 and 74.

In this way it is possible to join the plate 52, equipped with the balls, to an identical plate then to bond the plates to each other by adhesive coating.

As has been seen above, the invention makes it possible to couple up two optical components formed respectively on two plates made for example of silicon. It is possible for example to couple up in this way a first pumped laser of the VCSEL or vertical cavity surface emitting laser type and a second VCSEL laser facing the first VCSEL and pumped by it.

The plates comprising holes are preferably made of silicon, a material in which hole forming is commonly practised. Moreover silicon is a medium known in MEMS systems.

The holes may also be made in optical or fluidics materials used in the application under consideration, for example glasses or metals.

The alignment balls may be made of any desirable material, from corundum, a hard material, available in the form of balls, to stainless steel, a material available in the form of inexpensive calibrated balls.

The balls may even be made of a fusible material like for example a solder such as SnPb or In, materials which are available in the form of calibrated balls.

Indium solders are able to guarantee distortion and even pre-adhesion before bonding if they are put under pressure, on account of the adhesive properties of indium on all materials.

The present invention has numerous applications.

It applies for example to the coupling of an optical fibre, inserted into a cavity formed in one of the two supports which is being used and of a VCSEL formed in the other support.

The coupling of the fibre and of the VCSEL with an angle (such as the angle α in FIG. 1) makes it possible to avoid direct light reflection in the VCSEL. Moreover, such an angle is necessary in coupling optical fibres or, more generally, optical components, without a direct light return.

The invention also allows an optical fibre and a laser to be coupled in a detachable way. This is shown diagrammatically in FIG. 6 in which a lower plate 82 can be seen comprising three blind holes, like the holes 84 and 86 formed from the upper surface of this plate (the third hole cannot be seen in FIG. 6), and a VCSEL 88 which can be a light source or detector and which is formed from this upper surface.

An upper plate 90 is also used which is identical to the plate 82 except that its three holes, such as the holes 92 and 94 are not blind holes: they pass through this upper plate 90 (but could be blind in another example).

In the example in FIG. 6, all the holes have the same diameter and balls such as the balls 96 and 98 are used, having the same diameter (greater than the diameter of the holes) with the result that the angle formed by the surfaces of the plates 82 and 90, which are facing each other, is zero.

The upper plate 90 also comprises a blind hole into which the end of an optical fibre 100 has been inserted. The holes included in the assembly in FIG. 6 are provided in order that, when this assembly is formed, the axis of the core 104 of the optical fibre 100 meets the VCSEL 88.

A plate 90 is chosen made of a material transparent to the light which is intended to pass from the fibre to the VCSEL or reciprocally.

In an example not shown, an assembly is used of the same type as that in FIG. 6 in order to align an array of optical fibres with an array of light sources or detectors.

Also in FIG. 6 can be seen clamping springs 106 making it possible to clamp the plates 82 and 90 mechanically to each other.

The invention also has numerous applications in the field of MEMS: it may for example be used for covering a liquid crystal display screen.

1. A process for the passive alignment of at least one first support (2; 24₁, 24₂ . . . 24_{N}) and at least one second support (8; 26₁, 26₂ . . . 26_{N}), this process being characterised in that:
at least three first holes (6, 7; 38, 40, 44) are formed in the first support from a first surface of this first support,
at least three second holes (11, 12) are formed in the second support from a first surface of this second support, these second holes being able to be facing the first holes when the first surfaces of the first and second supports are placed facing each other,
balls (14, 16; 46, 48, 50) are placed on the first holes respectively, the size of each ball being greater than the size of the first hole corresponding to this ball and than the size of the second hole corresponding to this first hole, and
the first and second supports are assembled by placing the second holes onto the balls which are on the first holes corresponding respectively to these second holes,
and in that the sizes of the first and second holes and/or the sizes of the balls are chosen so as to obtain a pre-set non-zero angle between the first surfaces of the first and second assembled supports.

2. A process according to claim 1, wherein the first support is additionally clamped to the second support.

3. A process according to claim 2, wherein the first support is clamped to the second support using a technique chosen from among bonding by coating, the pre-depositing of an adhesive on the first support before assembling the first and second supports, localised bonding by gluing the balls before this assembly, and clamping by a mechanical clamping means (106).

4. A process according to any one of claims 2 and 3, wherein the assembly of the first and second supports is made to vibrate before they are clamped to each other.

5. A process according to any one of claims 1 to 4, wherein the first and second holes are not all of the same size.

6. A process according to claim 5, wherein the three first holes (38, 40, 44) are placed approximately at the apexes of an isosceles triangle, two of these three first holes being of approximately the same size and delimiting the base of this isosceles triangle while the third hole is of smaller size.

7. A process according to any one of claims 1 to 6, wherein N first supports (24₁, 24₂ . . . 24_{N}) and N second supports (26₁, 26₂ . . . 26_{N}) associated respectively with the N first supports are used, N being a whole number greater than one, each of the N assemblies of associated first and second supports is coated with a polymerisable adhesive (30) and the adhesive of the N assemblies is simultaneously cross-linked.

8. A process according to any one of claims 1 to 7, wherein the first and second supports are made of materials chosen from among silicon, quartz, glass and metals.

9. A process according to any one of claims 1 to 8, wherein the balls are made from a material chosen from among corundum, stainless steel and fusible materials.

10. A device for the passive alignment of at least one first support (2; 24₁, 24₂ . . . 24_{N}) and at least one second support (8; 26₁, 26₂ . . . 26_{N}), this device being characterised in that the first support includes at least three first holes (6, 7; 38, 40, 44) formed from a first surface of this first support and the second support includes at least three second holes (11, 12) formed from a first surface of this second support, these second holes being able to be facing the first holes when the first surfaces of the first and second supports are placed facing each other, the first holes being intended to receive balls allowing the assembly of the first and second supports by placing the second holes onto the balls which are on the first holes corresponding respectively to these second holes, the size of each ball being greater than the size of the first hole corresponding to this ball and than the size of the second hole corresponding to this first hole, and the sizes of the first and second holes and/or the sizes of the balls being chosen so as to obtain a pre-set non-zero angle (α) between the first surfaces of the first and second assembled supports.

11. A device according to claim 10, wherein the first support comprises at least one first optical component (18, 88) and the second support comprises at least one second optical component (20, 100) able to be facing the first optical component when the second holes are facing the first holes, the device thus allowing the passive alignment of the first optical component and of the second optical component.
